(19) United States
(12) Patent Application Publication
(10) Pub. No.: US 2006/0098254 A1
(43) Pub. Date: May 11, 2006

(54) Image processing system and image processing method

(75) Inventor: Yuki Tokuhashi, Hachioji-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 11/314,699

(22) Filed: Dec. 21, 2005

Related U.S. Application Data
(63) Continuation of application No. PCT/JP04/09264, filed on Jun. 24, 2004.

(30) Foreign Application Priority Data
Jun. 24, 2003 (JP) 2003-179877

(51) Int. Cl. G03F 3/08

(52) U.S. Cl. 358/518

(57) ABSTRACT

There is disclosed an image processing system capable of emphasizing color saturation of an image. A coefficient deciding section decides a color saturation emphasis coefficient in accordance with reliability of white balance at the time of photographing. A coefficient applying section executes color saturation emphasis processing for an image signal by using the color saturation emphasis coefficient decided by the coefficient deciding section.

### CROSS REFERENCE TO RELATED APPLICATIONS

This is a Continuation Application of PCT Application No. PCT/JP2004/009264, filed Jun. 24, 2004, which was published under PCT Article 21(2) in Japanese.

This application is based upon and claims the benefit of priority from prior Japanese Patent Application No. 2003-179877, filed Jun. 24, 2003, the entire contents of which are incorporated herein by reference.

### BACKGROUND OF THE INVENTION

1. Field of the Invention

The present invention relates to an image processing system and an image processing method.

2. Description of the Related Art

An image photographed by an electronic camera or the like is often subjected to automatic image processing to emphasize its color saturation. This is because when images are viewed, generally, an image faithful to the color of a photographed object seems duller than actual, and clearly emphasized images are preferred except for special purposes. Such image processing may be automatically executed in the camera to output a processed image, or an almost unprocessed image may be read from the camera by a personal computer and subjected to automatic image processing to be displayed on a screen. In both cases, a method of simple multiplication by a fixed coefficient is easiest for color saturation emphasis. However, problems may arise if the same processing is executed in all cases.

For example, noise may be contained in an image depending on photographing conditions. In such a case, when color saturation emphasis is applied by a great amount, noise is simultaneously emphasized to deteriorate an appearance. To deal with this, for example, in Japanese Patent Application No. 6-124329, emphasis of a low color saturation area is particularly suppressed to prevent increase of a color noise.

In Jpn. Pat. Appln. KOKAI Publication No. 2001-311867, an object or a photographing situation is estimated based on a selection situation of a close-up mode or a soft-focus mode to change processing contents such as color saturation emphasis.

### BRIEF SUMMARY OF THE INVENTION

According to a first aspect of the present invention, there is provided an image processing system capable of emphasizing color saturation of an image, comprising:

a coefficient deciding section which decides a color saturation emphasis coefficient in accordance with reliability of white balance at the time of photographing; and

a coefficient applying section which executes color saturation emphasis processing for an image signal by using the color saturation emphasis coefficient decided by the coefficient deciding section.

According to a second aspect of the present invention, there is provided an image processing system according to the first aspect, wherein the coefficient deciding section selects a small color saturation emphasis coefficient when the reliability of the white balance during the photographing is low.

According to a third aspect of the present invention, there is provided an image processing system capable of emphasizing color saturation of an image, comprising:

a white balance judgment section which judges reliability of white balance based on an image signal;

a coefficient deciding section which decides a color saturation emphasis coefficient in accordance with the reliability of the white balance determined by the white balance judgment section; and

a coefficient applying section which executes color saturation emphasis processing for an image signal by using the color saturation emphasis coefficient decided by the coefficient deciding section.

According to a fourth aspect of the present invention, there is provided an image processing method capable of emphasizing color saturation of an image, comprising:

a coefficient deciding step of deciding a color saturation emphasis coefficient in accordance with reliability of white balance at the time of photographing; and

a coefficient applying step of executing color saturation emphasis processing for an image signal by using the color saturation emphasis coefficient decided by the coefficient deciding step.

According to a fifth aspect of the present invention, there is provided an image processing method capable of emphasizing color saturation of an image, comprising:

a white balance judgment step of judging reliability of white balance based on an image signal;

a coefficient deciding step of deciding a color saturation emphasis coefficient in accordance with the reliability of the white balance determined by the white balance judgment step; and

a coefficient applying step of executing color saturation emphasis processing for an image signal by using the color saturation emphasis coefficient decided by the coefficient deciding step.

According to a sixth aspect of the present invention, there is provided an image processing system according to the first aspect, wherein the reliability of the white balance is defined in accordance with a positional relation between a position of the white balance coefficient in color signal space and a predetermined area indicating an achromatic color in the color signal space.

According to a seventh aspect of the present invention, there is provided an image processing system according to the third aspect, wherein the reliability of the white balance is defined in accordance with a positional relation between a position of the white balance coefficient in color signal space and a predetermined area indicating an achromatic color in the color signal space.

According to an eighth aspect of the present invention, there is provided an image processing system according to the sixth aspect, wherein the reliability is larger as a distance is smaller between the position of the white balance coefficient and the predetermined area.

According to a ninth aspect of the present invention, there is provided an image processing system according to the seventh aspect, wherein the reliability is larger as a distance is smaller between the position of the white balance coefficient and the predetermined area.

According to a tenth aspect of the present invention, there is provided an image processing system according to the sixth aspect, wherein the predetermined area includes a position of a signal corresponding to an illumination light source in the color signal space.

According to an eleventh aspect of the present invention, there is provided an image processing system according to the seventh aspect, wherein the predetermined area includes a position of a signal corresponding to an illumination light source in the color signal space.

According to a twelfth aspect of the present invention, there is provided an image processing system according to the sixth aspect, wherein the predetermined area includes a planckian locus in the color signal space.

According to a thirteenth aspect of the present invention, there is provided an image processing system according to the seventh aspect, wherein the predetermined area includes a planckian locus in the color signal space.

According to a fourteenth aspect of the present invention, there is provided an image processing method according to the fourth aspect, wherein the reliability of the white balance is defined in accordance with a positional relation between a position of the white balance coefficient in color signal space and a predetermined area indicating an achromatic color in the color signal space.

According to a fifteenth aspect of the present invention, there is provided an image processing method according to the fifth aspect, wherein the reliability of the white balance is defined in accordance with a positional relation between a position of the white balance coefficient in color signal space and a predetermined area indicating an achromatic color in the color signal space.

According to a sixteenth aspect of the present invention, there is provided an image processing method according to the fourteenth aspect, wherein the reliability is larger as a distance is smaller between the position of the white balance coefficient and the predetermined area.

According to a seventeenth aspect of the present invention, there is provided an image processing method according to the fifteenth aspect, wherein the reliability is larger as a distance is smaller between the position of the white balance coefficient and the predetermined area.

According to an eighteenth aspect of the present invention, there is provided an image processing system according to the fourteenth aspect, wherein the predetermined area includes a position of a signal corresponding to an illumination light source in the color signal space.

According to a nineteenth aspect of the present invention, there is provided an image processing system according to the fifteenth aspect, wherein the predetermined area includes a position of a signal corresponding to an illumination light source in the color signal space.

According to a twentieth aspect of the present invention, there is provided an image processing system according to the fourteenth aspect, wherein the predetermined area includes a Planckian locus in the color signal space.

According to a twenty-first aspect of the present invention, there is provided an image processing system according to the fifteenth, wherein the predetermined area includes a planckian locus in the color signal space.

### BRIEF DESCRIPTION OF THE SEVERAL VIEWS OF THE DRAWING

FIG. 1 is a diagram showing a configuration of an image processing system according to a first embodiment of the present invention.

FIG. 2 is a diagram showing a configuration example of a color saturation emphasizing section 107 of FIG. 1.

FIG. 3 is a diagram plotting a situation of a change in a noise amount with respect to a signal value level for each ISO sensitivity.

FIG. 4 is a diagram showing a table used for deciding a color saturation emphasis coefficient according to the first embodiment of the present invention.

FIG. 5 is a diagram showing a modified example of the first embodiment.

FIGS. 6A and 6B are diagrams showing tables used for deciding color saturation emphasis coefficients according to the modified example of the first embodiment.

FIG. 7 is a diagram showing a table used for deciding a color saturation emphasis coefficient according to a second embodiment of the present invention.

FIGS. 8A and 8B are diagrams illustrating WB shifting and color saturation emphasis.

FIG. 9 is a diagram showing a table used for deciding a color saturation emphasis coefficient according to a third embodiment of the present invention.

FIG. 10 is a diagram illustrating WB.

FIG. 11 is a diagram showing a table used for deciding a color saturation emphasis coefficient according to a fourth embodiment of the present invention.

FIG. 12 is a diagram showing a configuration of an image processing system according to a fifth embodiment of the present invention.

FIG. 13 is a diagram showing a table used for deciding a color saturation emphasis coefficient according to the fifth embodiment of the present invention.

FIG. 14 is a diagram illustrating software processing of color saturation emphasis.

### DETAILED DESCRIPTION OF THE INVENTION

### First Embodiment

[Configuration]

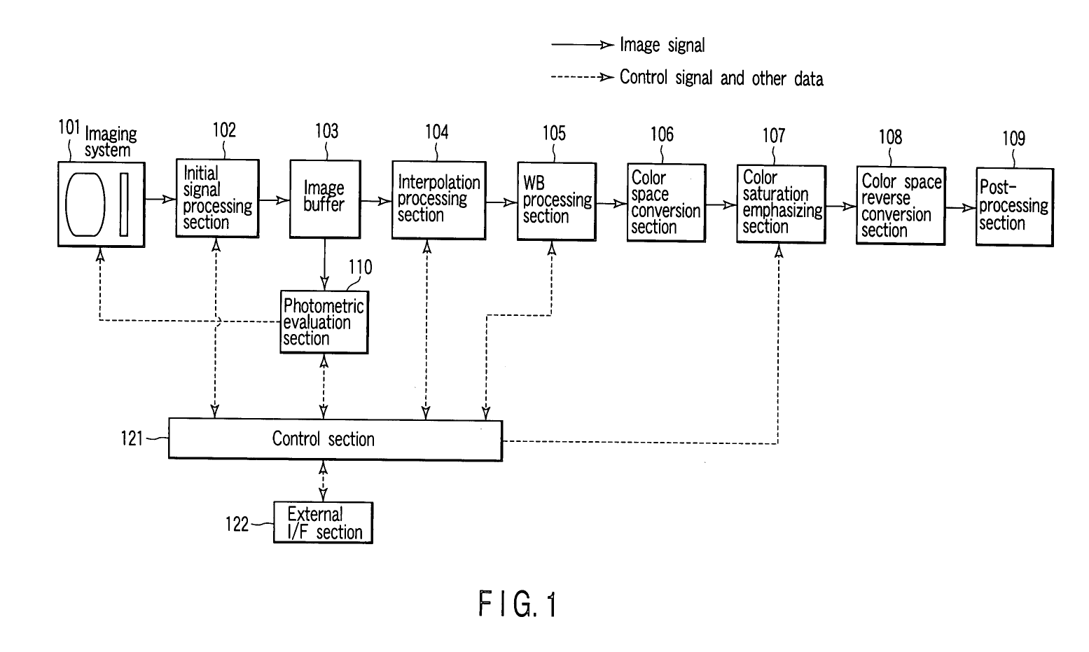

FIG. 1 is a diagram showing a configuration of an image processing system according to a first embodiment of the present invention. An initial signal processing section 102 for executing analog processing or analog-to-digital conversion for an image from an imaging system 101, an image buffer 103 for temporarily storing an image signal, an interpolation processing section 104, a white balance (WB) processing section 105, a color space conversion section 106, a color saturation emphasizing section 107, a color space reverse conversion section 108, and a post-processing section 109 for executing post-processing such as compression for an output from the color space reverse conversion section 108 are sequentially connected to the imaging system 101 for imaging an object. An output signal from the post-processing section 109 is supplied to a recording system (not shown).

The image buffer 103 is also connected to a photometric evaluation section 110, and the photometric evaluation section 110 is connected to the imaging system 101. The initial signal processing section 102, the interpolation processing section 104 and the WB processing section 105 are connected bidirectional with a control section 121 such as a microcomputer. A signal of the control section 121 is sent to the color saturation emphasizing section 107. Further, an external interface section 122 equipped with a power supply switch, a shutter button, and an interface for switching various modes at the time of photographing is connected bidirectional with the control section 121.

[Operation]

Hereinafter, an operation of the aforementioned configuration will be described in accordance with a signal flow. After setting photographing conditions such as an ISO sensitivity via the external interface section 122, an operator half-presses the shutter button via the external interface section 122 to enter a pre-photographing mode. An image signal photographed by the imaging system 101 is read as an analog signal at the initial signal processing section 102 to be amplified, and then converted into a digital signal to be transferred to the image buffer 103. The image signal in the image buffer 103 is transferred to the photometric evaluation section 110.

The photometric evaluation section 110 considers the set ISO sensitivity, a shutter speed, and the like to calculate proper exposure from a luminance level in the image, and controls an aperture in the imaging system 101, an electronic shutter speed, a signal amplification rate at the initial signal processing section 102, and the like.

The operator fully presses the shutter button via the external interface section 122 to execute real photographing, and an image signal is transferred to the image buffer 103 as in the case of the pre-photographing. The real photographing is executed based on exposure conditions obtained by the photometric evaluation section 110, and conditions at the time of photographing are transferred to the control section 121. The image signal in the image buffer 103 is divided into three image signals of R, G and B by the interpolation processing section 104, and subjected to interpolation processing to be transferred to the WB processing section 105. At the WB processing section 105, a WB coefficient is calculate so that an achromatic R, G and B ratio in the image can take a proper value.

The WB processing section 105 multiplies the RGB signal of the image by the calculated WB coefficient. Information of the WB coefficient is transferred to the control section 121. In addition, a preset WB coefficient can be set by manual operation. In this case, the WB processing section 105 multiplies the RGB signal of the image by the preset WB coefficient which transferred from the control section 121 via the external interface section 122. The image signal after WB processing is transferred to the color space conversion section 106. The color space conversion section 106 converts 3 image signals of RGB into 3 image signals Y, Cb, and Cr of predetermined color space, e.g., YCbCr space. Y, Cb, and Cr are calculated by the following equations:
Y=0.2999R+0.587G+0.114 B
Cb=0.169R−0.331G+0.500B
Cr=0.500R−0.419G−0.081B (1)

Accordingly, the RGB signal is separated into a luminance component Y and color components Cb, Cr. At the next color saturation emphasizing section 107, a predetermined coefficient is applied to the color components Cb, Cr to execute color saturation emphasis, and the signal is returned from the YCbCr space to the RGB space again by the color space reverse conversion section 108. The processed image signal is transferred to the post-processing section 109. The image is subjected to well-known compression processing or the like by the post-processing section 109 to be recorded and stored in a memory card or the like.

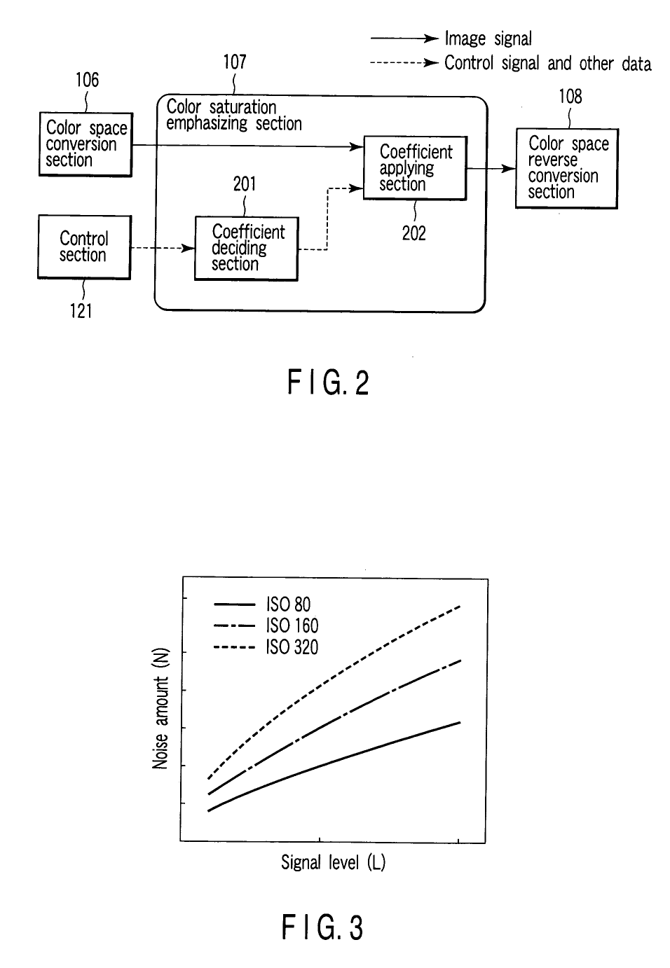

FIG. 2 shows a configuration example of the color saturation emphasizing section 107 of FIG. 1, and components similar to those of FIG. 1 are denoted by similar reference numerals. As shown in FIG. 2, the color saturation emphasizing section 107 includes a coefficient deciding section 201 and a coefficient applying section 202. The coefficient deciding section 201 obtains ISO sensitivity information from the control section 121, and decides a color saturation emphasis coefficient in accordance with the same. The coefficient applying section 202 multiplies the Cb, Cr signals input from the color space conversion section 106 by a color saturation emphasis coefficient k decided by the coefficient deciding section 201 to execute color saturation emphasis processing, and outputs a result to the color space reverse conversion section 108. The color saturation used here indicates an amount C represented by C=(Cb²+Cr²)^{1/2}, and the color saturation emphasis means multiplication of C by the coefficient k. This is substantially equal to multiplication of Cb, Cr by coefficients. That is, signals Cb′, Cr′ after color saturation emphasis are represented as follows:
Cb′=k×Cb
Cr′=k×Cr (2)

In this case, if the original R, G and B contain noise caused by the imaging system, noise (color noise) is also contained in Cb, Cr and, when the Cb, Cr are multiplied by coefficients, the noise is also multiplied by a coefficient.

Now, the noise will be described by referring to FIG. 3. FIG. 3 shows plotting of a situation of a change in a noise amount with respect to a signal value level for each ISO sensitivity. A noise amount can be represented by an equation of adding a constant term to a power function of a signal value level, and approximated by the following equation in which L is a signal value level and N is a noise amount:
N=αL^{β}+γ (3)

Here, α, β, and γ change depending on ISO sensitivities.

As shown in FIG. 3, the noise amount changes at each of R, G and B in accordance with a signal level L, and it is greater as an ISO sensitivity is larger. Thus, for example, even if no problem occurs when photographing is carried out at an ISO 80 to emphasize color saturation, a phenomenon may occur that color noise becomes conspicuous at an ISO 320.

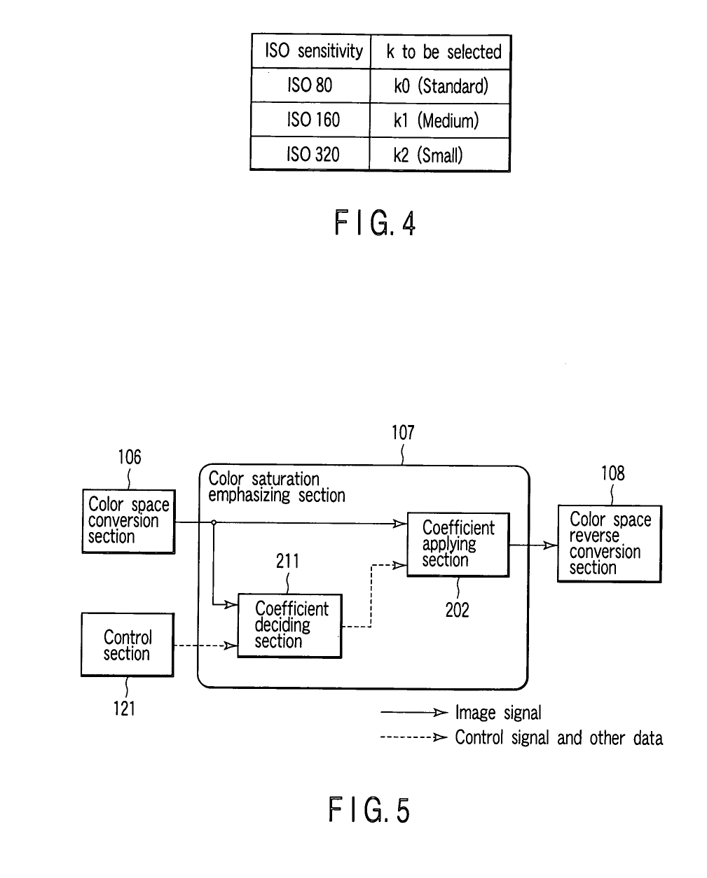

Therefore, the coefficient deciding section 201 of FIG. 2 holds a table similar to that shown in FIG. 4. When ISO sensitivity information is obtained from the control section 121, it refers to the table to select a color saturation emphasis coefficient k (one of k0, k1, and k2) in accordance with the obtained ISO sensitivity information. Here, k0 is a standard coefficient, e.g., 1.4, k1 is a coefficient slightly smaller than k0, e.g., 1.3, and k2 is a much smaller coefficient, e.g., 1.1. It is possible to invalidate color saturation emphasis by setting k to 1.0.

With this configuration, it is possible to prevent the color noise from being conspicuous by weakening color saturation emphasis when the noise amount is large.

Hereinafter, a modified example of the first embodiment will be described. The first embodiment has been described by way of case in which the color saturation emphasis coefficient k is constant (constant in image). However, k may change from image signal to image signal.

FIG. 5 is a diagram illustrating the modified example. FIG. 5 shows a configuration example of the color saturation emphasizing section 107 as in the case of FIG. 2. However, it is different in that 3 image signals Y, Cb, Cr as outputs of a color space conversion section 106 are input not only to a coefficient applying section 202 but also to a coefficient deciding section 211.

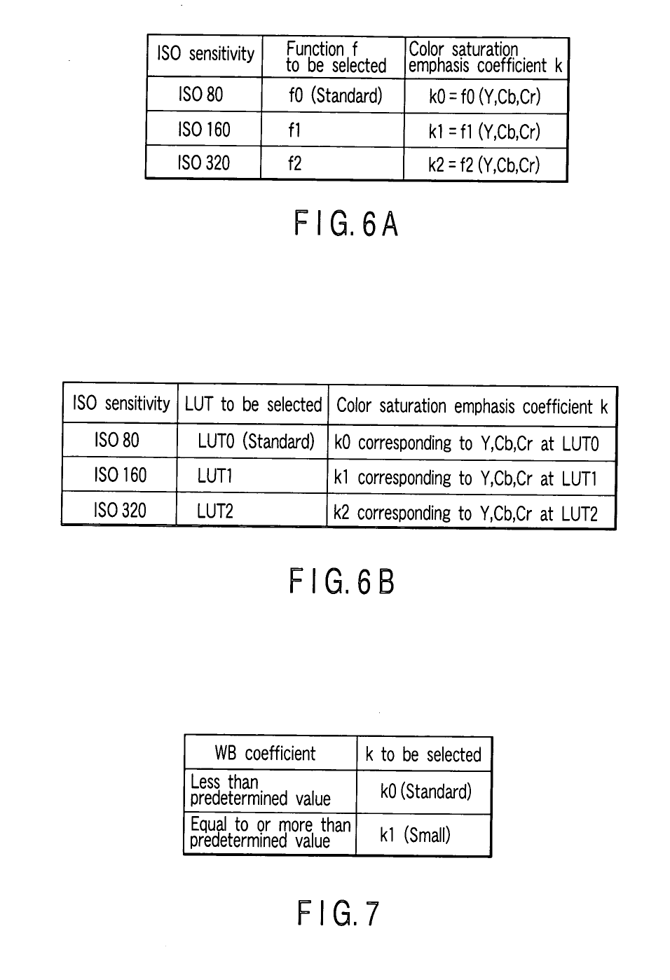

The coefficient deciding section 211 holds three kinds of functions f0, f1, and f2 similar to those of FIG. 6A as functions f (Y, Cb, Cr) of Y, Cb, Cr. The coefficient deciding section 211 selects a proper function f among the functions f0, f1 and f2 in accordance with ISO sensitivity information from a control section 121, and calculates a color saturation emphasis coefficient k0=f0 (Y, Cb, Cr), k1=f0 (Y, Cb, Cr) or k2=f0 (Y, Cb, Cr) by using the input 3 image signals Y, Cb and Cr to decide a color saturation coefficient k.

FIG. 6B is a diagram illustrating an example of deciding a color saturation coefficient by using a lookup table (LUT hereinafter) in place of the function. That is, the coefficient deciding section 211 selects a proper LUT from LUT0, lUT1, and LUT2 in accordance with ISO sensitivity information from the control section 121 to decide a color saturation emphasis coefficient k0, k1 or k2.

The function or the LUT is changed by such a method, whereby a color saturation emphasis coefficient of a pixel having a hue or luminance of conspicuous noise can be reduced only when noise is large. A correction coefficient may be selected in accordance with an ISO sensitivity, and this may be multiplied by a coefficient decided by the function or the LUT to be set as a last coefficient k. For example, it is useful when an LUT is used but it is difficult to hold a plurality of LUTs.

According to the modified example, YCbCr is used as color space for color saturation emphasis. Needless to say, however, uniform chromaticity scale space such as L*a*b* or other color space in which a calculation equation for conversion is simplified may be used.

According to the embodiment, the color saturation emphasis is carried out by the simple multiplication of the coefficient at the coefficient applying section 202. However, a coefficient application method is not limited to the multiplication. It may be applied in a form of addition and subtraction or a high-order function.

### Second Embodiment

The first embodiment has been described by way of case of changing the color saturation emphasis in accordance with the ISO sensitivity. A second embodiment described below is characterized by changing color saturation emphasis in accordance with a white balance (WB hereinafter) coefficient.

According to the embodiment, input signals to a coefficient deciding section and an operation are different from those of FIGS. 2 and 5. Other than these, an entire configuration and a configuration of a color saturation emphasizing section are similar to those of FIGS. 1, 2 and 5, and thus description of the configuration will be omitted.

Now, an operation of the coefficient deciding section will be described by referring to FIGS. 2 and 7. A coefficient deciding section 201 of FIG. 2 holds a table similar to that shown in FIG. 7. When WB coefficient information is obtained from a control section 121, the coefficient deciding section 201 refers to the table to select a color saturation emphasis coefficient in accordance with the obtained WB coefficient information. That is, k0 (standard) (e.g., 1.3) is selected when a WB coefficient is less than a predetermined value, and k1 (small) (e.g., 1.0 is selected when it is equal to or more than the predetermined value to weakly emphasize color saturation.

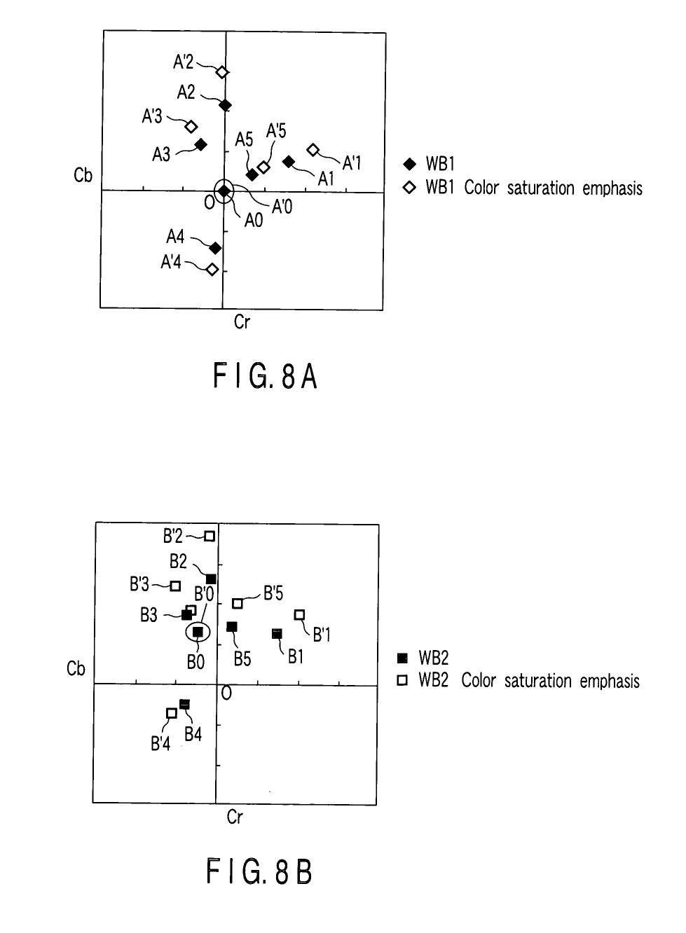

Hereinafter, a reason will be described by referring to FIGS. 8A, 8B. WB may not be sufficient in most cases when a WB coefficient is very large, and shifting may occur in other colors while a white color is good. RGB values of an entire screen or a place near an achromatic color in the screen are averaged to set an RGB ratio to 1. Consequently, WB may not be set properly when there is an image of very high color saturation or there is no image of an achromatic color in the screen.

FIG. 8A shows a relation between WB shifting and color saturation emphasis. FIG. 8A shows some colors of an image in which WB normally functions: the color signal Cr of the first embodiment is taken in an abscissa of a graph, and the color signal Cb is taken in an ordinate. Black rhombic shapes indicated by symbols A0 to A5 represent CbCr coordinates of original colors, while white rhombic shapes indicated by symbols A′0 to A′5 represent CbCr coordinates when color saturation emphasis is executed therefor. A0 is an achromatic point, and almost no change occurs in the coordinates even when color saturation is emphasized. For example, A0, A′0 remain on an origin 0. The entire screen is clearer, but almost no change occurs in hue.

On the other hand, FIG. 8B shows color coordinates when WB is shifted. Black squares indicated by symbols B0 to B5 represent CbCr coordinates of original colors, while white squares indicated by symbols B′0 to B′5 represent CbCr coordinates when color saturation emphasis is executed. In FIG. 8B, an achromatic point B0 is shifted from an origin 0, the coordinates of the entire screen are one-sided, and shifting is larger because of color saturation emphasis. Consequently, the entire image is seen colored. Accordingly, when there is large shift in white balance, it is advised not to set so large a color saturation emphasis amount. Thus, according to the embodiment, when a WB coefficient is equal to or more than a predetermined value, a color saturation emphasis coefficient of k1 is selected from the table of FIG. 7 to weakly emphasize color saturation.

With this configuration, when the WB is shifted, color saturation emphasis is weakened to enable prevention of appearance deterioration caused by excessively large coloring of an image. According to the embodiment, when a color saturation emphasis coefficient is adaptively decided from Y, Cb, and Cr values of an image as shown in FIG. 5, a function, an LUT, or a correction coefficient may be selected in place of the directly selected coefficient k.

### Third Embodiment

A third embodiment is characterized by changing color saturation emphasis in accordance with both of a white balance (WB) coefficient and ISO sensitivity.

According to the embodiment, input signals to a coefficient deciding section and an operation are different from those of FIGS. 2 and 5. Other than these, an entire configuration and a configuration of a color saturation emphasizing section are similar to those of FIGS. 1, 2 and 5, and thus description of the configuration will be omitted.

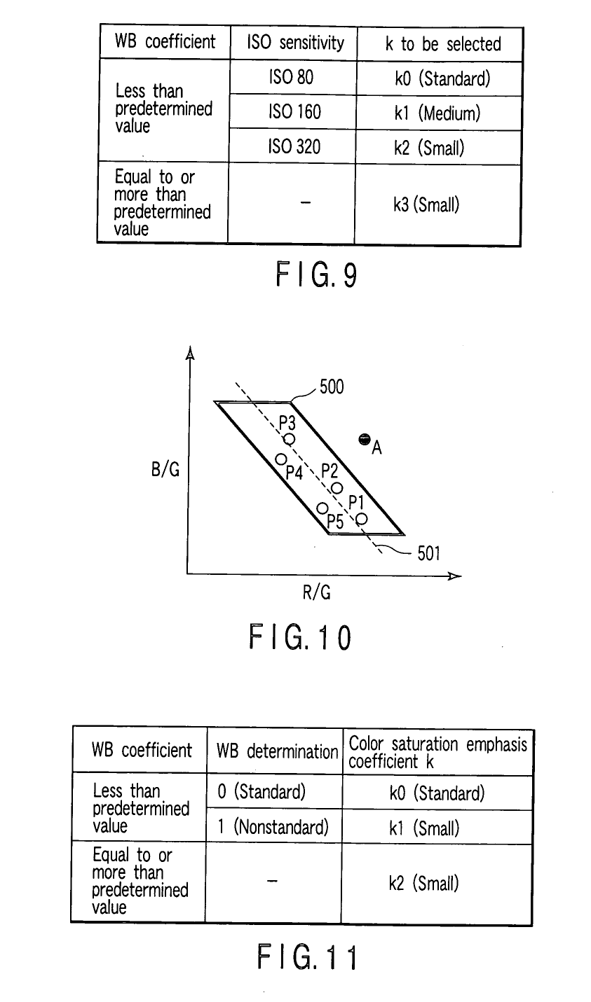

Hereinafter, an operation of the coefficient deciding section of the embodiment will be described by referring to FIGS. 2 and 9. A coefficient deciding section 201 of FIG. 2 holds a table similar to that shown in FIG. 9. When WB coefficient information and ISO sensitivity information area are obtained from a control section 121, the coefficient deciding section 201 refers to the table to select a color saturation emphasis coefficient in accordance with values of the obtained WB coefficient information and ISO sensitivity information. That is, when a WB coefficient is equal to or more than a predetermined value, a small coefficient k (k3) is selected irrespective of ISO sensitivity. On the other hand, when a WB coefficient is less than the predetermined value, a color saturation emphasis coefficient k is selected in accordance with ISO sensitivities (ISO 80, ISO 160, and ISO 320): a standard coefficient k0 is selected in the case of the ISO 80, a medium color saturation emphasis coefficient k1 is selected in the case of the ISO 160, and a small color saturation emphasis coefficient k2 is selected in the case of the ISO 320.

With this configuration, when the WB is shifted, or the amount of noise is large, color saturation emphasis is weakened to enable prevention of appearance deterioration caused by excessively large coloring of an image or conspicuous noise.

According to the third embodiment, first, determination is made as to whether the WB coefficient is equal to or more than the predetermined value, or less than the predetermined value. However, determination may first be made as to whether an ISO sensitivity is equal to or more than a predetermined value, or less than the predetermined value. Then, when the ISO sensitivity is less than the predetermined value, a color saturation emphasis coefficient k may be decided in accordance with a size of the WB coefficient.

### Fourth Embodiment

The second embodiment has been described by way of case of changing the color saturation emphasis in accordance with the WB coefficient. A fourth embodiment described below is characterized by changing color saturation emphasis in accordance with WB determination information (reliability of white balance) indicating presence of white balance shifting.

According to the embodiment, an entire configuration and a configuration of a color saturation emphasizing section are similar to those of FIGS. 1, 2 and 5, and thus description of the configuration will be omitted. According to the embodiment, an output signal and an operation from the WB processing section 105 to the control section 121 shown in FIG. 1, and an input signal and an operation to the coefficient deciding sections 201, 211 of FIGS. 2 and 5 are different.

That is, the WB processing section 105 selects a preheld preset value as a WB coefficient when WB setting set before photographing and transferred to the control section 121 is a preset mode. A WB coefficient is automatically calculated when the WB setting is an automatic mode. The WB coefficient selected in the preset mode or calculated in the automatic mode is transferred to the control section 121, multiplied by an RGB signal of an image, and then transferred to a color space conversion section 106. The WB processing section 105 transfers WB determination information together with the WB coefficient to the control section 121. The coefficient deciding section 201 of FIG. 2 and the coefficient deciding section 211 of FIG. 5 obtains the WB determination information and the WB coefficient from the control section 121, and selects a color saturation emphasis coefficient in accordance with the obtained WB determination information and WB coefficient.

Hereinafter, automatic calculation of a WB coefficient will be described by referring to FIG. 10. First, a ratio of R and G (R/G hereinafter), a ratio of B and G (B/G hereinafter) and luminance are obtained from the RGB signal of the image. If R/G, B/G and luminance are within a predetermined range (white determination area 500 of FIG. 10), a pixel is taken as white, and an R/G average value and a B/G average value are calculated for a pixel determined to be white to be set as a WB coefficient.

If the image has no white, or the calculated WB coefficient shifts from the white determination area as in the case of a point A of FIG. 10, one of a plurality of preheld preset values (among preset values P1 to P5 in the white determination area 500, preset values P1, P2 and P3 on the right more than a color temperature approximate line 501) is selected as a WB coefficient. Which preset value is selected may be decided based on a shifting direction from the white determination area.

If the image has no white, or the calculated WB coefficient shifts from the white determination area as in the case of the point A of FIG. 10, effects of white balance may not be enough and shifting of color may occur. Therefore, the WB processing section 105 transfers a value (e.g., 0) indicating standard as WB determination information to the control section 121 when the calculated WB coefficient is used, and a value (e.g., 1) indicating nonstandard as WB determination information to the control section 121 when a preset value is selected from the calculated WB coefficient determination result.

Hereinafter, an operation of the coefficient deciding section will be described by referring to FIGS. 2 and 11. A coefficient deciding section 201 of FIG. 2 holds a table similar to that shown in FIG. 11. When WB coefficient and WB determination information are obtained from the control section 121, the coefficient deciding section 201 refers to the table to select a color saturation emphasis coefficient in accordance with values of the obtained WB coefficient and WB determination information. That is, a smallest color saturation coefficient k2 (e.g., 1.0) is selected irrespective of WB determination information when a WB coefficient is equal to or more than a predetermined value. A color saturation emphasis coefficient k is selected based on the WB determination information when the WB coefficient is less than the predetermined value. That is, a standard color saturation emphasis coefficient k0 (e.g., 1.3 to 1.4) is selected when the WB determination is standard, and a slightly smaller color saturation emphasis coefficient k1 (e.g., 1.1) is selected when the WB determination is nonstandard. Thus, when the WB determination information is nonstandard (value 1) even if the WB coefficient is less than the predetermined value, a color saturation emphasis coefficient k is reduced.

With this configuration, not only the WB coefficient but also the WB determination information are obtained, and color saturation emphasis is weakened when the WB is shifted, whereby appearance deterioration caused by excessively large coloring of an image can be prevented. According to the embodiment, when a color saturation emphasis. coefficient is adaptively decided from Y, Cb, and Cr values of an image as shown in FIG. 5, a function, an LUT, or a correction coefficient may be selected in place of the directly selected coefficient k.

Moreover, in place of making WB determination upon determination as to whether the WB coefficient is less than the predetermined value or not as described above, a color saturation emphasis coefficient k may be decided only by WB determination.

### Fifth Embodiment

The fourth embodiment has been described by way of example in which the color saturation emphasis is changed in accordance with the WB determination information. According to a fifth embodiment described below, however, a color saturation emphasizing section includes a WB determination section for determining presence of white balance shifting, and color saturation emphasis is changed in accordance with a WB determination result, a WB mode and a WB coefficient.

An entire configuration of the embodiment is similar to that of FIG. 1, and thus description thereof will be omitted. However, a configuration of a color saturation emphasizing section 107 is different, and thus it will be described below.

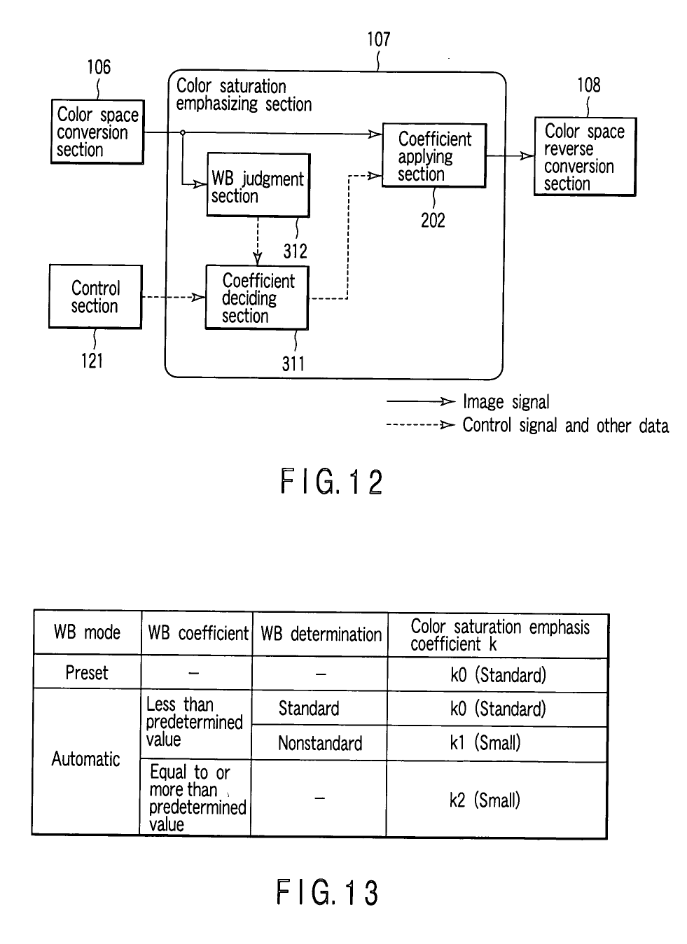

FIG. 12 shows a configuration of the color saturation emphasizing section 107 of the embodiment, which includes a WB determination section 312 in addition to a coefficient applying section 202 and a coefficient deciding section 311. In FIG. 12, components similar to those of FIGS. 2 and 5 are denoted by similar reference numerals.

In FIG. 12, an image signal from a color space conversion section 106 is input to the coefficient applying section 202 and the WB determination section 312. The coefficient deciding section 311 is connected to a control section 121, the coefficient applying section 202, and the WB determination section 312 to decide a color saturation emphasis coefficient in accordance with an output of the WB determination section 312 and a WB mode and a WB coefficient obtained from the control section 121.

The WB determination section 312 takes average values Cb0, Cr0 of Cb, Cr, and sends results thereof to the coefficient deciding section 311. Cb0, Cr0 are close to 0 when WB processing is working. However, if a preset value is selected in an automatic mode as described above with reference to the fourth embodiment, the average values Cb0, Cr0 are shifted from 0. Accordingly, a nonstandard state is determined when one of Cb0, Cr0 is equal to or more than a predetermined value.

The coefficient deciding section 311 holds a table similar to that shown in FIG. 13. When a WB mode and a WB coefficient are obtained from the control section 121 and a WB determination result is obtained from the WB determination section 312, it refers to the table to select a color saturation emphasis coefficient in accordance with the obtained information. That is, determination is first made as to whether a WB mode is a preset or automatic mode. In the case of the preset mode, a standard color saturation emphasis coefficient k0 is selected irrespective of a WB coefficient or a WB determination result. In the case of the automatic mode, determination is made as to whether a WB coefficient is less than a predetermined value, or equal to or more than the predetermined value. If the WB coefficient is equal to or more than the predetermined value, a small color saturation emphasis coefficient k2 is selected irrespective of a WB determination result. Further, if the WB coefficient is less than the predetermined value in the automatic mode, determination is made as to whether WB determination is standard or nonstandard. A standard color saturation emphasis coefficient k0 is selected when it is standard. A small color saturation emphasis coefficient k1 is selected when it is nonstandard.

Thus, when the WB mode is an automatic mode and the WB coefficient is equal to or more than the predetermined value, or when the WB mode is an automatic mode and the WB coefficient is less than the predetermined value, and the WB determination is nonstandard, a small color saturation emphasis coefficient is set.

With this configuration, determination is made as to WB shifting based on a determination result of the WB determination section 312 and information on the WB mode and the WB coefficient, and color saturation is weakened when a level of shifting is large, whereby it is possible to prevent deterioration of appearance caused by excessively large coloring of the image.

According to the embodiment, when a color saturation coefficient is adaptively decided from Y, Cb, and Cr values as shown in FIG. 5, a function, an LUT or a correction coefficient may be selected in place of the directly selected coefficient k.

(Processing By Software)

Each of the aforementioned embodiments employs the configuration of executing the color saturation emphasis processing during the photographing. However, the invention is not limited to this configuration. For example, it is possible to employ a configuration of using a photographed signal as unprocessed Raw data, outputting an ISO sensitivity at the time of photographing, a WB mode, WB determination information, a WB coefficient, or the like as header information from the control section 121, and separately executing processing by software.

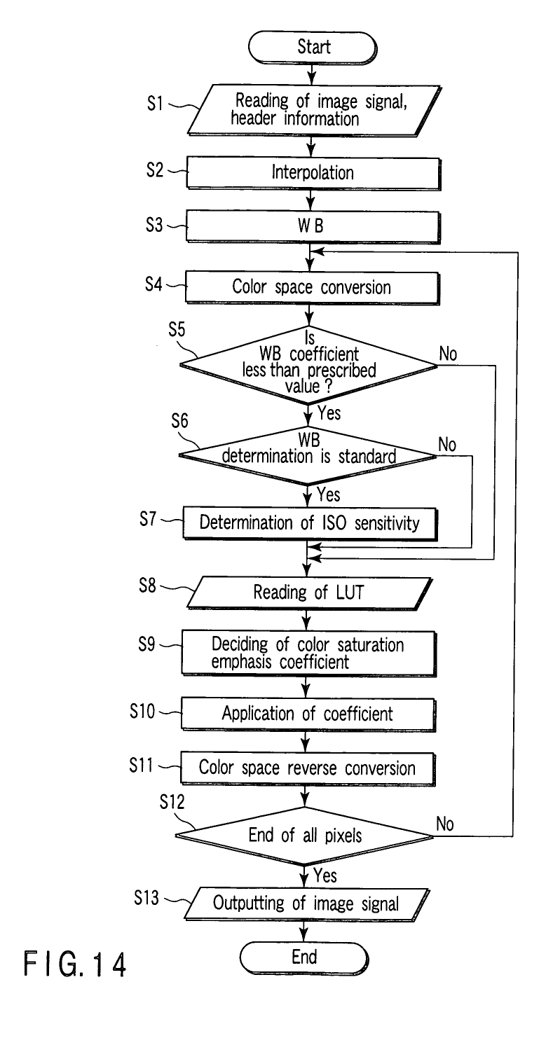

FIG. 14 is a flowchart showing an example of a software processing flow of color saturation emphasis. In step S1, an image signal and header information such as ISO sensitivity, WB mode, WB determination information, WB coefficient or the like are read. In step S2, three images of R, G and B are generated by well-known linear interpolation. In step S3, a white balance coefficient is obtained from the header information to execute white balance processing. In step S4, color space conversion is executed to calculate Y, Cb, and Cr from RGB. In step S5, a WB coefficient is obtained from the header information. If the WB coefficient is equal to or more than a predetermined value, an LUT name is selected to proceed to step S8. If the WB coefficient is less than the predetermined value, WB determination information is obtained from the header information in step S6. If the WB determination information is nonstandard, a predetermined LUT name is selected to proceed to the step S8. If the WB judgment information is standard in step S6, ISO sensitivity is obtained from the header information in step S7 to select an LUT name to be read in accordance with a value. The LUT (coefficient compliant with a pixel is correlated thereto) selected in the step S8 is read, and a color saturation emphasis coefficient k is calculated from the LUT in step S9. In step S10, the coefficient k is applied to each of Cb, Cr. In step S11, color space reverse conversion is executed to return from a YCbCr signal to an RGB signal. In step S12, determination is made as to an end of processing for all the pixels. If not ended, the process of the steps S4 to S11 is repeated. If ended, in step S13, an image signal is output to finish the process.

According to all the embodiments, YCbCr is used as color space to execute color saturation emphasis. Needless to say, however, uniform chromaticity scale space such as L*a*b*, or other color space in which a calculation equation for conversion is simplified may be used.

Furthermore, the color saturation emphasis is executed by simple multiplication of the coefficient at the coefficient applying section 202. However, the coefficient application method is not limited to the multiplication. It may be applied in a form of addition and subtraction or a high-order function.

(Note)

Inventions of the following configurations can be extracted from the aforementioned specific embodiments.

1. An image processing system capable of emphasizing color saturation of an image, comprising:

a coefficient deciding section which decides a color saturation emphasis coefficient in accordance with reliability of white balance at the time of photographing; and

a coefficient applying section which executes color saturation emphasis processing for an image signal by using the color saturation emphasis coefficient decided by the coefficient deciding section.

### Corresponding Embodiments

The fourth embodiment shown in FIGS. 1, 2, 5, and 11 corresponds to the embodiment of this invention. The coefficient deciding section in the configuration corresponds to the coefficient deciding section 201 shown in FIG. 2 and the coefficient deciding section 211 shown in FIG. 5, and the coefficient applying section in the configuration corresponds to the coefficient applying section 202 shown in FIGS. 2 and 5. The reliability of the white balance in the configuration corresponds to the WB determination information sent from the WB processing section 105 shown in FIG. 1.

(Operation)

The coefficient deciding section selects a color saturation emphasis coefficient in accordance with reliability of white balance at the time of photographing, whereby color saturation emphasis is weakened under conditions of large white balance shifting.

(Effect)

It is possible to prevent deterioration of appearance caused by enlarged coloring (hue shifting) of an entire image because of color saturation emphasis.

2. An image processing system capable of emphasizing color saturation of an image, comprising:

a white balance judgment section which determines reliability of white balance based on an image signal;

a coefficient deciding section which decides a color saturation emphasis coefficient in accordance with the reliability of the white balance determined by the white balance judgment section; and

a coefficient applying section which executes color saturation emphasis processing for an image signal by using the color saturation emphasis coefficient decided by the coefficient deciding section.

### Corresponding Embodiments

The fifth embodiment shown in FIGS. 1, 12, and 13 corresponds to the embodiment of this invention. The white balance judgment section in the configuration corresponds to the WB determination section 312 in FIG. 12, the coefficient deciding section in the configuration corresponds to the coefficient deciding section 311 shown in FIG. 12, and the coefficient applying section in the configuration corresponds to the coefficient applying section 202 shown in FIG. 12.

(Operation)

The WB determination section determines reliability of white balance based on an image signal, and the coefficient deciding section selects a color saturation emphasis coefficient in accordance with the determination result of the WB determination section, whereby color saturation emphasis is weakened under conditions of large white balance shifting.

(Effect)

It is possible to prevent deterioration of appearance caused by enlarged coloring (hue shifting) of an entire image because of color saturation emphasis.

3. An image processing method capable of emphasizing color saturation of an image, comprising:

a coefficient deciding step of deciding a color saturation emphasis coefficient in accordance with reliability of white balance at the time of photographing; and

a coefficient applying step of executing color saturation emphasis processing for an image signal by using the color saturation emphasis coefficient decided by the coefficient deciding step.

(Corresponding embodiments), (operation), and (effect) are similar to those of 3.

4. An image processing method capable of emphasizing color saturation of an image, comprising:

a white balance judgment step of determining reliability of white balance based on an image signal;

a coefficient deciding step of deciding a color saturation emphasis coefficient in accordance with the reliability of the white balance determined by the white balance judgment step; and

a coefficient applying step of executing color saturation emphasis processing for an image signal by using the color saturation emphasis coefficient decided by the coefficient deciding step.

(Corresponding embodiments), (operation) and (effect) are similar to those of 4.

What is claimed is:

1. An image processing system capable of emphasizing color saturation of an image, comprising:
a coefficient deciding section which decides a color saturation emphasis coefficient in accordance with reliability of white balance at the time of photographing; and
a coefficient applying section which executes color saturation emphasis processing for an image signal by using the color saturation emphasis coefficient decided by the coefficient deciding section.

2. The image processing system according to claim 1, wherein the coefficient deciding section selects a small color saturation emphasis coefficient when the reliability of the white balance during the photographing is low.

3. An image processing system capable of emphasizing color saturation of an image, comprising:
a white balance judgment section which determines reliability of white balance based on an image signal;
a coefficient deciding section which decides a color saturation emphasis coefficient in accordance with the reliability of the white balance determined by the white balance judgment section; and
a coefficient applying section which executes color saturation emphasis processing for an image signal by using the color saturation emphasis coefficient decided by the coefficient deciding section.

4. An image processing method capable of emphasizing color saturation of an image, comprising:
a coefficient deciding step of deciding a color saturation emphasis coefficient in accordance with reliability of white balance at the time of photographing; and
a coefficient applying step of executing color saturation emphasis processing for an image signal by using the color saturation emphasis coefficient decided by the coefficient deciding step.

5. An image processing method capable of emphasizing color saturation of an image, comprising:
a white balance judgment step of determining reliability of white balance based on an image signal;
a coefficient deciding step of deciding a color saturation emphasis coefficient in accordance with the reliability of the white balance determined by the white balance judgment step; and
a coefficient applying step of executing color saturation emphasis processing for an image signal by using the color saturation emphasis coefficient decided by the coefficient deciding step.

6. The image processing system according to claim 1, wherein the reliability of the white balance is defined in accordance with a positional relation between a position of the white balance coefficient in color signal space and a predetermined area indicating an achromatic color in the color signal space.

7. The image processing system according to claim 3, wherein the reliability of the white balance is defined in accordance with a positional relation between a position of the white balance coefficient in color signal space and a predetermined area indicating an achromatic color in the color signal space.

8. The image processing system according to claim 6, wherein the reliability is larger as a distance is smaller between the position of the white balance coefficient and the predetermined area.

9. The image processing system according to claim 7, wherein the reliability is larger as a distance is smaller between the position of the white balance coefficient and the predetermined area.

10. The image processing system according to claim 6, wherein the predetermined area includes a position of a signal corresponding to an illumination light source in the color signal space.

11. The image processing system according to claim 7, wherein the predetermined area includes a position of a signal corresponding to an illumination light source in the color signal space.

12. The image processing system according to claim 6, wherein the predetermined area includes a planckian locus in the color signal space.

13. The image processing system according to claim 7, wherein the predetermined area includes a planckian locus in the color signal space.

14. The image processing method according to claim 4, wherein the reliability of the white balance is defined in accordance with a positional relation between a position of the white balance coefficient in color signal space and a predetermined area indicating an achromatic color in the color signal space.

15. The image processing method according to claim 5, wherein the reliability of the white balance is defined in accordance with a positional relation between a position of the white balance coefficient in color signal space and a predetermined area indicating an achromatic color in the color signal space.

16. The image processing method according to claim 14, wherein the reliability is larger as a distance is smaller between the position of the white balance coefficient and the predetermined area.

17. The image processing method according to claim 15, wherein the reliability is larger as a distance is smaller between the position of the white balance coefficient and the predetermined area.

18. The image processing system according to claim 14, wherein the predetermined area includes a position of a signal corresponding to an illumination light source in the color signal space.

19. The image processing system according to claim 15, wherein the predetermined area includes a position of a signal corresponding to an illumination light source in the color signal space.

20. The image processing system according to claim 14, wherein the predetermined area includes a planckian locus in the color signal space.

21. The image processing system according to claim 15, wherein the predetermined area includes a planckian locus in the color signal space.
